(19) United States
(12) Patent Application Publication
(10) Pub. No.: US 2008/0209395 A1
(43) Pub. Date: Aug. 28, 2008

(54) AUTOMATIC CODE REPLACEMENT

(75) Inventor: Brett Ernst, Lynnwood, WA (US)

Correspondence Address: Jablonski Law Group, 11609 NE 97th St, KIRKLAND, WA, 98033, US

(73) Assignee: Advance 9 Group LLC, Lynnwood, WA (US)

(21) Appl. No.: 11/679,751

(22) Filed: Feb. 27, 2007

(51) Int. Cl. G06F 9/44

(52) U.S. Cl. 717/115

(57) ABSTRACT

A machine-implemented method for serving web content to a client having a web browser. In one embodiment the method includes browsing to a page at a server having active content, wherein the active content is written in a language unsupported by the web browser. The method continues as the server decompiles the active content into one or more object models representing the active content. Then, the server compiles the object model into active content that is written in a language that is supported by the web browser. Finally, the new active content is served to the client computer.

### FIELD

Web developers and programs have an array of programming languages at their disposal for creating and authoring web pages and web content. Such languages include client-side languages like JavaScript and server-side languages like PERL, C, C++, C#, Visual Basic, VBScript, and VB.NET. Several additional and emerging languages are also at the disposal of a web programmer. With such an array of choices of language, invariably translation and interpretation of these languages is required across various platforms. In but one example of a problematic situation, not all browsers interpret these languages the same when translating from server-side to client-side and some web browsers may not even recognize certain commands and functions.

One of the aforementioned web-enabled programming languages is JavaScript. JavaScript is a prototype-based scripting language heavily influenced by Java with a syntax that is a basic derivative of C. JavaScript may sometimes be referred to as ECMA Script (a standard approved by the European Computer Manufacturers Association (ECMA)). One major use of web-based JavaScript is to write functions that are embedded in or included from HTML pages and interact with the Document Object Model (DOM) of the page to perform tasks not possible in HTML alone. Some common examples include opening a new window with programmatic control over the size, position and ‘look’ of the new window and validation of web form input values to make sure that they will be accepted before they are submitted to the server.

The DOM interfaces in various browsers differ and don't always match the W3C DOM standards. Rather than write different variants of a JavaScript function for each of the many browsers in common use today, it is usually possible, by carefully following the W3C DOM Level 1 or 2 standards, to provide the required functionality in a standards-compliant way that most browsers will execute correctly. However, it is more likely that web programmers do not take such steps and simply code as they are most familiar. Other examples of JavaScript interacting with a web page's DOM have been called DHTML and SPA.

In addition to DOM implementation differences, there are additional objects implemented in each browser for which there is no relevant specification, but for which there is a loose agreement or “de-facto” standard. This functionality always differs more than the DOM implementations. One example would be the Window object, representing the browser window or frame. Even a strict following of DOM Level 1 or 2 standards may not ensure interoperability because there can be small quirks or differences in the interpretation of those standards by browser developers.

Yet another example of the use of JavaScript in web pages is to make calls to web and web-service servers after a web page has loaded. In particular, depending upon user actions, various web-enabled services may be invoked. These calls can obtain new information, which further JavaScript can merge with the existing page's DOM so that it is displayed. Such active content is sometimes called AJAX (Asynchronous JavaScript and XML) which is a term commonly used to reference active content that contacts servers and web services Asynchronous JavaScript and XML.

Furthermore, aside from traditional web-based applications, JavaScript interpreters may typically be embedded in a number of tools. For example, Adobe Acrobat and Adobe Reader support JavaScript in PDF files. The Mozilla platform, which underlies several common web browsers, uses JavaScript to implement the user interface and transaction logic of its various products. JavaScript interpreters are also embedded in proprietary applications that lack scriptable interfaces. Dashboard Widgets in Apple's Mac OS X v10.4 are implemented using JavaScript. Microsoft's Active Scripting technology supports JavaScript-compatible JScript as an operating system scripting language. JScript NET is a CLI-compliant language that is similar to JScript, but has further object oriented programming features. Tools in the Adobe Creative Suite, including Photoshop, allow scripting through JavaScript.

Thus, clearly JavaScript is a language in common use both within and without web-based applications. Not all web browsers, however, support function calls in JavaScript the same as various syntax changes across various platforms. While syntax differences may be minimized by following the ECMA Script standard, application programming interfaces (API) handling the JavaScript still leads to errors. Common browsers in the market today include Microsoft Internet Explorer, Safari, Mozilla Firefox, Netscape Navigator, and Opera. Specific problems arise as JavaScript is interpreted across different platforms that may or may not recognize the particular syntax of JavaScript. As newer and more powerful web-programming languages are developed and used, such as C# and Visual Basic.NET, programmers tend toward using these more powerful languages, but these server-side languages do not translate to client-side implementation. This is problematic as many browsers still use JavaScript for basic web functionality and the like. As web browsing programs will not focus on handling C#, Visual Basic.Net and the like, a consistent and reliable interpretation of JavaScript based programming is required.

C# is an object-oriented programming language developed by Microsoft as part of their .NET initiative, and later approved as a standard by ECMA and ISO. C# has a procedural, object-oriented syntax based on C++ that includes aspects of several other programming languages (most notably Delphi and Java) with a particular emphasis on simplification (fewer symbolic requirements than C++, fewer declarative requirements than Java.

Visual Basic .NET (VB.NET) is an object-oriented computer language that can be viewed as an evolution of Microsoft's Visual Basic (VB) implemented on the Microsoft .NET framework. The great majority of VB.NET developers use Visual Studio .NET as their integrated development environment (IDE). Like all .NET languages, programs written in VB.NET require the .NET framework to execute.

With regards to problems with JavaScript, the majority of problems are typically because of the nature of the language. While C# and VB are fully object-oriented languages that support the representation of business logic, JavaScript has shortcomings in terms of expressing that logic: Such shortcomings include weak object-oriented support (lack of real class inheritance, virtual methods), no type checking that leads to runtime errors that are difficult to diagnose, limited support for events (the ability to subscribe to and capture events that occur in the environment and within objects), and syntax that leads to ambiguity in developing logic.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of a suitable computing environment in which various embodiments of the methods disclosed herein may be implemented;

FIG. 2 illustrates an exemplary architecture of a networked system in which automatic code translation may be accomplished according to one embodiment disclosed herein;

FIG. 3 shows a flow chart of a method for serving web content to a web browser using automatic code replacement according to one embodiment disclosed herein;

FIG. 4 shows a flow chart of another method for serving web content to a web browser using automatic code replacement according to one embodiment disclosed herein; and

FIG. 5 shows a flow chart of yet another method for serving web content to a web browser using automatic code replacement according to one embodiment disclosed herein.

### DETAILED DESCRIPTION

The following discussion is presented to enable a person skilled in the art to make and use the invention. The general principles described herein may be applied to embodiments and applications other than those detailed above without departing from the spirit and scope of the present invention. The present invention is not intended to be limited to the embodiments shown, but is to be accorded the widest scope consistent with the principles and features disclosed or suggested herein.

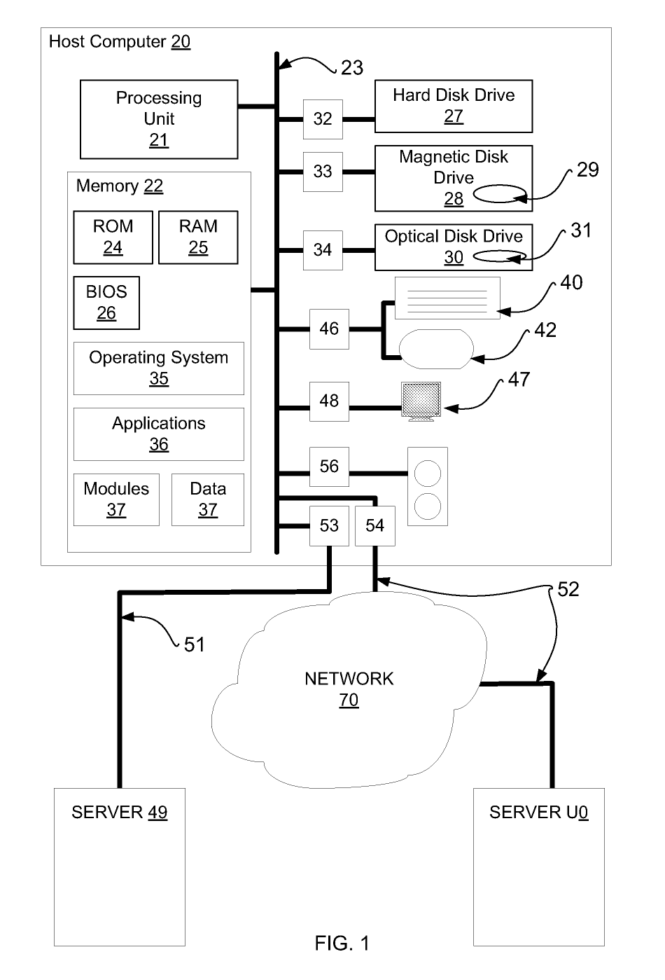

FIG. 1 and the following discussion are intended to provide a brief, general description of a suitable computing environment in which various embodiments of the methods disclosed herein may be implemented. Although not required, the invention will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

With reference to FIG. 1, an exemplary system for implementation includes a general purpose computing device in the form of a conventional personal computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer-readable media provide nonvolatile storage of computer readable instructions, data structures, program modules and other data for the personal computer 20. Although the exemplary environment described herein employs a hard disk, a removable magnetic disk 29 and a removable optical disk 31, it should be appreciated by those skilled in the art that other types of computer-readable media which can store data that is accessible by a computer, such as magnetic cassettes, flash memory cards, digital versatile disks, Bernoulli cartridges, random access memories (RAMs), read only memories (ROM), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. One or more speakers 57 are also connected to the system bus 23 via an interface, such as an audio adapter 56. In addition to the monitor and speakers, personal computers typically include other peripheral output devices (not shown), such as printers.

The personal computer 20 typically operates in a networked environment using logical connections to one or more remote computers, such as remote server computers 49 and 60. Each remote computer 49 or 60 may be another personal computer, a server, a router, a network PC, a peer device or other common network node, and typically includes many or all of the elements described above relative to the personal computer 20, although only a memory storage device 50 or 61 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet. As depicted in FIG. 1, the remote computer 60 communicates with the personal computer 20 via the local area network 51. The remote computer 49 communicates with the personal computer 20 via the wide area network 52 via a network 70 that typically includes the Internet (i.e. World Wide Web).

When used in a LAN networking environment, the personal computer 20 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via a serial port interface. In a networked environment, program modules depicted relative to the personal computer 20, or portions thereof, may be stored in the remote memory storage device. It will be appreciated that the network connections shown are exemplary and other means of establishing a communications link between the computers may be used.

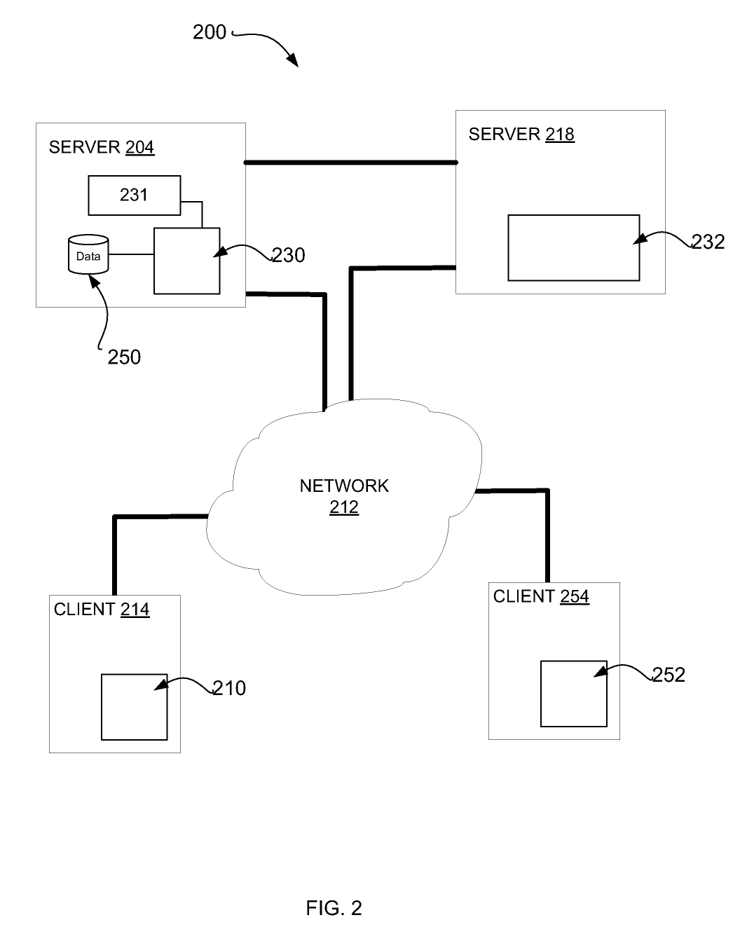

FIG. 2 illustrates an exemplary architecture of a networked system in which automatic code translation may be accomplished according to one embodiment disclosed herein. The computer network 200 may be a local area network 51 (FIG. 1), a wide area network 52 (FIG. 1), or a combination of networks that allow a server computer 204 to communicate with remote computers, such as the remote server computer 218, either directly or indirectly. The server computer 204 and the remote server computer 218 may be similar to the personal computer 20 depicted in FIG. 1 and discussed above.

A client computer 214, such as the personal computer 20 (FIG. 1), is connected to the server computer 204 by a computer network 212. The computer network 212 may be a local area network, a wide area network, or a combination of networks. The client computer 214 includes a computer program, such as a “browser” 215 that locates and displays documents to a user. Additional client computers, such as client computer 254 with additional computer programs, such as web browser 235 may also be part of the computer network 200. These browser may be any common or newly developed browser including browser software such as Microsoft Internet Explorer, Safari, Mozilla Firefox, Netscape Navigator, and Opera.

With this network 200, a machine-implemented method for serving web content may be accomplished. In an overview, one embodiment of the method comprises from a client 214 having a web browser 210, browsing to a page at a server having active content, wherein the active content is written in a language unsupported by the web browser 210. The method continues as the server decompiles the active content into one or more object models representing the active content. Then the server 204 compiles the object model into active content that is written in a language that is supported by the web browser 214. Finally, the new active content is served to the client computer 214. These steps are discussed in more detail below.

Active content, as used herein, refers to content that may be served by a server computer that imparts some functionality to a client computer. Active content may be distinguished from non-active content by the physical location of any execution of functions that occur. Active content invokes a client computer to execute some code in order to realize functionality. For example, a simple JavaScript module may cause the display of a new browser window or cause an image in a displayed web page to move about with respect to user activity. Non-active content does not invoke any execution of any code on the client computer.

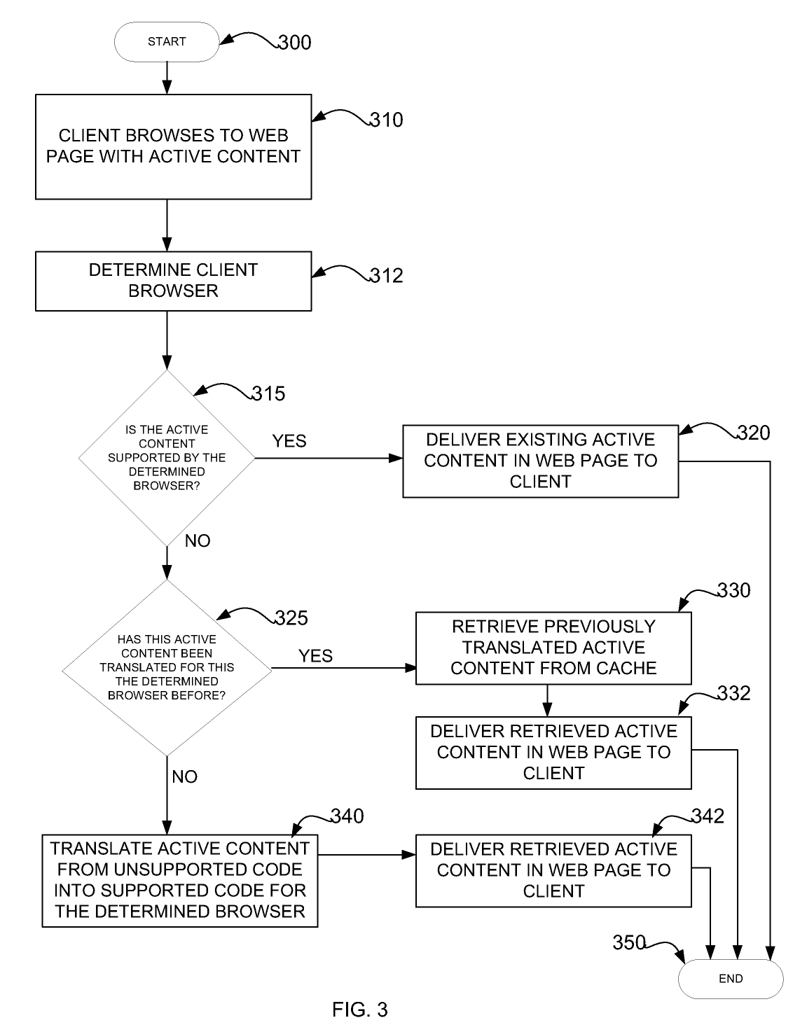

As discussed in the background section, there are numerous examples of web-based programming languages that may be used to create active content for web pages. Such languages include client-side languages like JavaScript and server-side languages like C#, and VB.NET. As has been discussed, not all web browsers handle these languages the same and translation from one language to another is often required in order for correct functionality to be realized. One method for handling this coding discrepancy is discussed in conjunction with FIG. 3.

FIG. 3 shows a flow chart of a method for serving web content to a web browser using automatic code replacement according to one embodiment disclosed herein. The method begins at step 300 and proceeds to step 302 where a client computer 214 may be used to browse to a web page having active content. Browsing to a web page may be accomplished in a conventional manner, such as clicking a link or entering a Universal resource locator (URL) at the client computer 214. As is well known, the web page request is routed to the appropriate server computer 204 based on the URL entered. When the appropriate server computer 204 receives a request for a webpage, the appropriate web page is then “served” to the client computer 214 using a web server application 230. In the context of this method, prior to serving the web page the method of FIG. 3 continues as active content is analyzed.

Thus, at step 312, the server computer 204 determines which web browser application 210 is currently executing on a client computer 214. As has been discussed above, a typical determination of a web browser 210 may include Microsoft Internet Explorer, Safari, Mozilla Firefox, Netscape Navigator, and Opera. This determination may be accomplished in a conventional manner, such as a request for information (i.e., a user agent string) or any other method for determining an actual we browser application 210 that is executing on the client computer 214. Once the server computer 204 has identified the web browser 210 that is executing on the client computer 214, the server computer 204 may then proceed to its next decision.

At step 315, the server computer 204 determines whether or not the active content that has been requested by the client computer 214 is able to be executed on the client computer 214 in conjunction with the determined web browser 210. If the server computer 204 determines that the requested active content poses no problem with regard to the determined web browser 210, then the server computer 204 simply delivers the existing active content in the requested web page to the client computer 214 at step 320. The method may then end at step 350. If, however, the server computer 204 determines that the requested active content is not able to be supported by the determined web browser 210 of the client computer 214 than the method proceeds to an additional decision block at step 325.

At step 325, the server computer 204 determines whether or not the requested active content has been previously translated from its current coding to a coding able to be supported by the determined web browser 210 of the client computer 214. If the server computer 204 determines that this particular active content has previously been translated (because the server computer 204 has encountered this situation before and caches results), then the server computer 204 simply retrieves, at step 320, the previously translated active content corresponding to the determined web browser executing on the client computer 214 from a cache 250 of previously translated active content. Once this active content code has been retrieved from the cache 250, the server computer 204 serves the previously stored active content code to the web browser 210 of the client computer 214 at step 322. The method may then end at step 350.

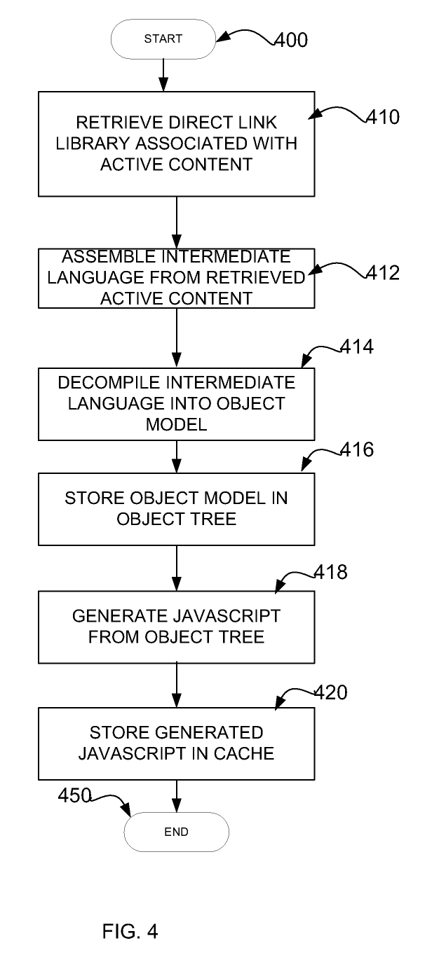

If, however, the server computer 204 determines that this particular active content has not been previously translated (and consequently stored in the cache 250), then translation may be required. Proceeding then to step 340, a translation application 231 at the server computer 204 may be invoked to decompile and recompile the active content into code suitable to be supported by the determined web browser 210 of the client computer 214. This decompiling and recompiling method is described in more detail below in FIG. 4. Once translated by the translation application 231, the translated active content code may then be served to the web browser of the client computer at step 342 before the method ends at step 350.

The various steps of this method discussed above may be permutated such that one or more of the individual steps may be accomplished by a second server computer 218 having a second Web service application 232. For example, a second client computer 254 having a second Web browser application 252 may request a web page having active content from a second server computer 218. The second server computer 218 may determine that the active content requested is coated such that it is unsupported by the determined web browser 252 on the second client computer 254. The second server computer 218 may then determine that this particular active content has previously been translated by the first server computer 204 and a translation of this active content code is stored in the cache 250. Thus the second server computer 218 communicates with the first server computer 204 to retrieve the previously translated active content code from the cache 250 before serving the translated active content code to the second client computer 254.

Furthermore, the second server computer may determine that the requested active content code needs to be translated and may send a request for translation to the first server computer 204 such that the translation application 231 that resides their own translates the active content code into code that is supported by the web browser 252 on the second client computer 254. Other such permutations of the method of FIG. 3 are contemplated but not discussed herein for brevity.

FIG. 4 shows a flow chart of another method for serving web content to a web browser using automatic code replacement according to one embodiment disclosed herein. When a server computer 204 determines that automatic code translation is to be invoked by a translation application 231 executing thereon (i.e., a “no” decision at step 325 of FIG. 3), the method of FIG. 4 may be initiated.

This method begins at step 400 when automatic code translation is required. At step 410, the translation application retrieves a dynamic link library (DLL) that is associated with the active content code to be translated. A DLL is a file that exists on disk or in memory that contains a set of classes, functions and instructions that make up a unit of executable code. A DLL can be invoked in order to create (instantiate) objects and then execute code defined by those objects.

In object oriented programming, when Intermediate Language (IL) is retrieved from a DLL, it is transformed into an object model that is referred to as the “ECMA Script DOM.” This is an object model that contains entities consistent with the ECMA-262 (ECMA Script) specification. Each logical unit of code is represented as an object, with attached child objects where appropriate. For example, to logically represent the statement “print(x)”, there would be a function call object (or “node”) for the call to the printo function, and it would have a single child object that references the parameter to the print function (namely, the variable “x”). These objects themselves could be part of a larger chunk of code, and in that case, the printo function call node would be a child of another node.

Thus, when representing all IL code in a tree format, the tree can get very deep and complex depending on the complexity of the logic being represented. One reason to use an object model to represent code is that it becomes practical to manipulate the logic and replace pieces of it. For example, one can traverse the tree looking for function calls and replace them with suitable logic for the target browser. Another property of the object model is that it knows how to render itself into a textual output, meaning that each object in the tree knows how it should be represented in actual code. This allows the ability to quickly and easily convert the tree to textual code to be sent to the browser.

From the DLL the translation application is able to assemble intermediate language code, at step 412 that represents a more basic breakdown of the functionality of the active content, i.e., programmatic tasks underlying the active content. At step 414, the intermediate language is decompiled into an object model code.

Once the active content is represented in an object model code, it may be then stored in object tree representing the function and structure of the active content at step 416. In object tree is a commonly used arrangement of data that allows a programmer to more easily access and reference various aspects of the underlying intentions of the active content that has been decompiled. From the object tree, the translation application may then generate new code that will be supported by the determined web browser application 210 of the client computer 214 requesting the active content. In one typical embodiment, the translation application generates code in a JavaScript language, such that the generated code is specific to determined web browser 210. Once generated, the translated active code may be stored in the cache 250, at step 420 before the method ends at step 450.

The method of FIG. 4 may be further characterized in that generating code in a JavaScript language further comprises: identifying function calls in the intermediate language code and then replacing each identified function call with a an output code that corresponds with each respective identified function call. With this approach, each output code corresponding to code supported by the determined browser before reassembling the output codes.

In but one example, a typical code translation may look like this. HTML elements (pieces of an HTML document tree) in the Microsoft browser Internet Explorer have a property called “innerText” which can be used to set the raw, textual content of the node. This applies to nodes that hold text, such as a label or a textbox. When this property is set, the text belonging to the node is replaced with a new set of text (or a new text node). In Firefox, as well as other browsers in the Mozilla family, this property is called textContent.

To handle this, a new pseudo-property would be created called InnerText for the programmer to use. When the programmer calls the function that gets or sets that property, the appropriate script is rendered depending on the user's browser. For IE, something like “object.innertext=value” would be rendered, whereas in Firefox, something like “object.textContent=value” would be rendered.

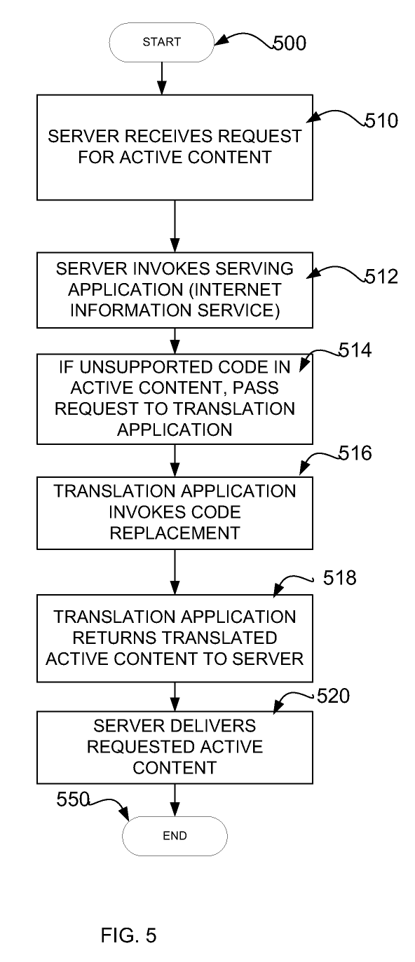

FIG. 5 shows a flow chart of yet another method for serving web content to a web browser using automatic code replacement according to one embodiment disclosed herein. In this method that starts at step 500, a server computer 204 may receive a request from client computer for a particular active content typically in the context of a web page at step 510. At step 512 once the request has been received by the server computer 204, the server computer typically invokes a serving application, i.e., and Internet information service, to determine how the request should be handled. In the context of this method, the Internet information service may determine that the underlying active content in the requested webpage is unsupported by the web browser application 210 of the client computer 214 at step 514. Thus, a request for translation is passed along to the translation application 231. At step 516, the translation application 231, translates the active content code into a language that is supported by the web browser application 210 of the client computer 214. At step 518, the translation application 231 returns the translated active content to a server computer 204 via the Internet information service. Finally at step 520 the server computer 204 may then serve the newly translated active content in the context of a webpage to the web browser application 210 of the client computer 214 before the method ends at step 550.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A machine-implemented method for serving web content, the method comprising:
from a client having a web browser, browsing to web content at a server having active content, the active content written in a language unsupported by the we browser;
at the server, decompiling the active content into one or more object models representing the active content;
compiling the object model from the tree format into active content written in a language that is supported by the browser; and
serving the web page to the client with the active content written in a language that is supported by the browser.

2. The method of claim 1, further comprising determining the type of web browser at the client machine wherein the determined web browser is determined to be a web browser from the group comprising: Microsoft Internet Explorer, Safari, Mozilla Firefox, Netscape Navigator, and Opera.

3. The method of claim 2 wherein the decompiling further comprises:
retrieving a direct link library associated with the active content;
assembling intermediate language code from the direct link library representing a programmatic task underlying the active content; and
generating code in a JavaScript language, the generated code specific to determined web browser.

4. The method of claim 3 wherein generating code in a JavaScript language further comprises:
identifying function calls in the intermediate language code;
replacing each identified function call with a an output code that corresponds with each respective identified function call, each output code corresponding to code supported by the determined browser; and
reassembling the output codes.

5. The method of claim 1, further comprising: storing the decompiled active content in a tree format, the tree format operable to facilitate replacing function calls in a native code with function calls in a JavaScript code.

6. A machine-implemented method for serving web content, the method comprising:
from a client having a web browser, browsing to a page at a server having active content, the active content written in a language unsupported by the we browser;
determining if the active content has previously been decompiled and recompiled into active content written in a language supported by the web browser;
if the active content has been previously decompiled and recompiled, serving the web page to the client having the previously decompiled and recompiled active content; and
if the active content has not been previously decompiled and recompiled, at the server, decompiling the active content into an object model of the active content;
storing the object model in a tree format;
compiling the object model from the tree format into active content written in a language that is supported by the browser; and
serving the web page to the client with the active content written in a language that is supported by the browser.

7. The method of claim 6 further comprising storing previously decompiled and recompiled active content in a cache at the server.

8. The method of claim 7, further comprising updating the cache with recompiled active content if the active content has not been previously decompiled and recompiled.

9. The method of claim 6, further comprising determining the type of web browser at the client machine wherein the determined web browser is determined to be a we browser from the group comprising: Microsoft Internet Explorer, Safari, Mozilla Firefox, Netscape Navigator, and Opera.

10. The method of claim 9 wherein the decompiling further comprises:
retrieving a direct link library associated with the active content;
retrieving intermediate language code from the direct link library representing a programmatic task underlying the active content; and
generating code in a JavaScript language, the generated code specific to determined web browser.

11. The method of claim 10 wherein generating code in a JavaScript language further comprises:
identifying function calls in the intermediate language code;
replacing each identified function call with a an output code that corresponds with each respective identified function call, each output code corresponding to code supported by the determined browser; and
reassembling the output codes.

12. The method of claim 6, further comprising: storing the decompiled active content in a tree format, the tree format operable to facilitate replacing function calls in a native code with function calls in a JavaScript code.

13. A machine-readable medium having machine-executable instructions for serving web content, the machine-executable instructions operable to:
from a client having a web browser, browse to a page at a server having active content, the active content written in a language unsupported by the we browser;
at the server, decompile the active content into one or more object models representing the active content;
compile the object model from the tree format into active content written in a language that is supported by the browser; and
serve the web page to the client with the active content written in a language that is supported by the browser.

14. The machine-readable medium of claim 13 wherein the machine-executable instructions to decompile further comprise instructions to:
retrieve a direct link library associated with the active content;
assemble intermediate language code from the direct link library representing a programmatic task underlying the active content; and
generate code in a JavaScript language, the generated code specific to determined web browser.

15. The machine-readable medium of claim 14 wherein the machine-executable instructions for generating code in a JavaScript language further comprise instructions to:
identify function calls in the intermediate language code;
replace each identified function call with a an output code that corresponds with each respective identified function call, each output code corresponding to code supported by the determined browser; and
reassemble the output codes.

16. A system for serving web content to a client computer, the system comprising:
a server computer having a web service thereon operable to serve web pages with active content to a client computer, the web service operable to:
determine a web browser operating on the client computer and determine that the active content is unsupported by the web browser;
decompile the active content into one or more object models representing the active content;
compile the object models into active content written in a language that is supported by the browser; and
serve the web page to the client with the active content written in a language that is supported by the browser.

17. The system of claim 16 wherein the server computer further comprises a cache for storing previously decompiled and recompiled active content such that active content that is stored in the cache for an identified browser may be retrieved from the cache and served to the client computer without decompiling and recompiling the active content.

18. The system of claim 17 further comprising a database coupled to the server, the database hosting the cache and communicatively coupled to the server.

19. The system of claim 16, further comprising a second client computer having a second browser running thereon, the server computer communicatively coupled to the second client computer and operable to:
determine the web browser operating on the second client computer and determine that the active content is unsupported by the second web browser;
decompile the active content into one or more object models representing the active content;
compile the object models into active content written in a language that is supported by the second browser; and
serve the web page to the second client computer with the active content written in a language that is supported by the second browser.

20. The system of claim 16, further comprising a second server computer communicatively coupled to the server computer, the second server computer operable to receive and forward requests for active content from one or more client computers to the server computer.
